(19) United States
(12) Patent Application Publication
(10) Pub. No.: US 2010/0165992 A1
(43) Pub. Date: Jul. 1, 2010

(54) Transmission system, device and method that prevent data loss

(75) Inventors: Jer Hong Suen, Taipei (TW); Liang Wei Hsu, Taipei (TW)

Correspondence Address: BACON & THOMAS, PLLC, 625 SLATERS LANE, FOURTH FLOOR, ALEXANDRIA, VA, 22314-1176, US

(73) Assignee: Moxa Inc., Taipei (TW)

(21) Appl. No.: 12/318,367

(22) Filed: Dec. 29, 2008

(51) Int. Cl. H04L 12/56

(52) U.S. Cl. 370/392

(57) ABSTRACT

This specification discloses a transmission system, device and method that prevent data loss. The invention uses a first channel and a second channel to send same packet encapsulating same target data to a receiving end. After confirming the reception of the packet, the receiving end drops the duplicated packet. The receiving end only processes yet processed packet. This technique can reduce the chances of losing data.

### BACKGROUND OF THE INVENTION

1. Field of Invention

The invention relates to a data transmission system, device and method. More particular, it relates to a transmission system, device and method that prevent data loss.

2. Related Art

A wireless local area network (LAN) uses radio waves as the medium for transmitting data. It often uses cables as its main structure to connect with several wireless devices. Users of the wireless LAN have to use another wireless device to connect with a wireless device connected to the main structure. The data transmission between the two wireless devices can be ad hoc. Alternatively, it can be arranged through a base station (BS) or an access point (AP). Such wireless LAN's have been widely used in schools, airports, and other public areas.

Since the wireless LAN uses radio waves to transmit data, the data are very susceptible to environmental interference during the transmission process, resulting in data damages. Therefore, in such an environment, there is a mechanism for re-transmitting data. When a receiving end receives the data, it returns an acknowledging message ACK to the transmitting end. After receiving the acknowledging message, the transmitting end knows that the data have correctly arrived at the receiving end. If the transmitting end does not receive the acknowledging message within a certain time, it automatically sends the same data to the receiving end. Through such a mechanism, data losses can be avoided. However, during this process, the amount of data that can be transmitted is reduced, rendering a longer transmission time.

In summary, the prior art long has the problem of data loss due to interference during the transmission process. It therefore needs a re-sending mechanism and elongates the transmission time. Therefore, it is desirable to provide a better solution for this.

### SUMMARY OF THE INVENTION

In view of the foregoing, the invention discloses a transmission system, device and method that can prevent data loss.

The disclosed transmission device that prevents data loss includes: an encapsulating module for encapsulating first target data into a first packet with first header information; a first transmitting module for using a first channel to transmit the first packet and using the first channel for receiving a second packet that contains second target data and second header information; a second transmitting module for using a second channel to transmit the first packet and using the second channel to receive the second packet; a determining module for using transmission identification (ID) data in the second header information to determine whether the second target data have been received before when the first or second transmitting module receives the second packet; a storing module for storing the transmission ID code when the determining module determines that the second target data have not been received before; a packet processing module for processing the target data when the determining module determines that the second target data have not been received before. The first transmitting module and the second transmitting module are used to transmit/receive the same packet. When the determining module determines that the received packet has been received before, the transmission device drops the received packet. When the determining module determines that the received packet has not been received before, the packet processing module processes the target data. This solves the problems existing in the prior art.

The disclosed transmission system that prevents data loss includes: a transmitting end and a receiving end. The transmitting end encapsulates target data into a packet containing header information, and uses first and second channels to transmit the packet. The header information includes the transmission ID code. The receiving end uses the first and second channels to wait and receive the packet. After the packet is received and the target data are determined to be not received before from the transmission ID code, the transmission ID code are stored and the target data are processed. When the target data are determined to be received before from the transmission ID code, the packet is dropped. Through the transmitting end, the same packet is transmitted to the receiving end via the first and second channels. The receiving end drops packets that have been received before and processes those that have not been received before. Hence, the invention can solve the problems existing in the prior art.

The disclosed transmission method that prevents data loss includes the steps of: encapsulating target data at the transmitting end into a packet containing header information; transmitting the packet to the receiving end using a first channel and a second channel by the transmitting end; using the first and second channels to transmit the packet to the receiving end by the transmitting end; using the first and second channels to wait and receive the packet by the receiving end. After the receiving end receives the packet, the following steps are executed. When the receiving end uses the transmission ID code in the header information to determine that the target data have not been received before, the transmission ID code are stored and the target data are processed. When the receiving end uses the transmission ID code in the header information to determine that the target data have been received before, the packet is dropped. The same packet is transmitted via the first and second channels to the receiving end. The receiving end automatically drops packets that have been received before and processes those that have not been received before. Hence, the invention can solve the problems existing in the prior art.

According to the above description, the disclosed system and method differ from the prior art in that the transmitting end uses the first and second channels to transmit a packet containing the same target data to the receiving end. The receiving end automatically drops packets that have been received before and processes those that have not been received before. Using the above-mentioned technique, the invention achieves the effect of reducing the chances of losing data.

### BRIEF DESCRIPTION OF THE DRAWINGS

The invention will become more fully understood from the detailed description given herein below illustration only, and thus is not limitative of the present invention, and wherein:

FIG. 1 shows the structure of the disclosed transmission system that prevents data loss.

FIG. 2 is a schematic view of the transmitting device in the disclosed transmission system that prevents data loss.

FIG. 3A is a flowchart of the disclosed transmission method that prevents data loss.

FIG. 3B is a flowchart of the appended procedure in the disclosed transmission method that prevents data loss.

FIG. 3C is a flowchart of the appended procedure in the disclosed transmission method that prevents data loss.

FIG. 4A is a schematic view of the packet format according to an embodiment of the invention.

FIG. 4B is a schematic view of the packet format according to another embodiment of the invention.

### DETAILED DESCRIPTION OF THE INVENTION

The present invention will be apparent from the following detailed description, which proceeds with reference to the accompanying drawings, wherein the same references relate to the same elements.

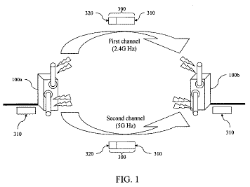

FIG. 1 shows the structure of the disclosed transmission system that prevents data loss. As shown in the drawing, the disclosed system includes a transmitting end 100a and a receiving end 100b.

The transmitting end 100a encapsulates target data 310 to be transmitted to the receiving end 100b into a packet 300 containing header information 320. The header information 320 includes at least transmission ID code for the receiving end 100b to determine whether the target data 310 have been received before. Generally speaking, the transmission ID code is some sequence number generated by the transmission end 100a. However, the invention is not limited to this possibility. Any algorithm that can produce non-repeated data can be adopted by the invention.

After the transmitting end 100a encapsulates the target data 310 into the packet 300, the first channel and the second channel are used to transmit the packet 300 of the target data 310 to the receiving end 100b. The first and second channels can be in the same band. For example, they both use different frequencies in the band of 2.4 GHz˜2.4835 GHz. They can also be in different bands, e.g., one in the band of 2.4 GHz˜2.4835 GHz and the other in the band of 5.15 GHz˜5.35 GHz.

The receiving end 100b uses the same first and second channels used by the transmitting end 100a to wait and receive the packet 300. After the receiving end 100b receives the packet 300 transmitted by the transmitting end 100a, either using the first or second channel, the receiving end 100b uses the transmission ID code of the header information 320 in the received packet 300 to determine whether the target data 310 encapsulated in the packet 300 have been received before. Generally speaking, the receiving end 100b uses a specific file to store the transmission ID code in the header information 320, and determines whether the target data 310 have been received before by checking whether the received transmission ID code have been stored in the specific file. But the method of determining whether the target data 310 have been received or not used in the invention is not limited to this example.

When the receiving end 100b determines that the target data 310 in the packet 300 have not been received before, the transmission ID code in the header information 320 of the packet 300 are stored (in the above-mentioned specific file). The received packet 300 is processed correspondingly. For example, the target data 310 are transferred to other devices. When the receiving end 100b determines that the target data 310 in the packet 300 have been received before, the packet 300 is dropped. The received packet 300 is not processed at all.

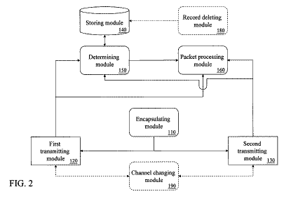

Between the transmitting end 100a and the receiving end 100b, data transmissions are not one way only. If the receiving end 100b needs to transmit data to the transmitting end 100a, then the roles of the receiving end 100b and the transmitting end 100a are interchanged. That is, both the transmitting end 100a and the receiving end 100b can be integrated into a transmitting device with data transmitting and receiving functions. The integrated transmitting device, as shown in FIG. 2, includes an encapsulating module 110, a first transmitting module 120, a second transmitting module 130, a storing module 140, a determining module 150, and a packet processing module 160.

For the convenience of explanation, the packet transmitted by the transmitting device in this specification is also called a first packet. The header information and the target data in the first packet are called the first header information and the first target data, respectively. Likewise, the packet received by the transmitting device in this specification is also called a second packet. The header information and the target data in the second packet are called the second header information and the second target data, respectively.

The encapsulating module 110 encapsulates the first target data into the first packet containing the first header information.

The first transmitting module 120 uses the first channel to transmit the first packet produced after the encapsulating module 110 encapsulates the first target data. During the free time of data transmissions, it also uses the first channel to wait and receive the second packet transmitted from another transmitting device using the invention.

The second transmitting module 130 uses the second channel to transmit the first packet produced by the encapsulating module 110. During the free time of data transmissions, it also uses the second channel to wait and receive the second packet transmitted from another transmitting device using the invention.

After the first transmitting module 120 or the second transmitting module 130 receives the second packet, the determining module 150 uses the transmission ID code in the second header information of the second packet received by the first transmitting module 120 or the second transmitting module 130 to determine whether the second target data have been received before.

When the determining module 150 determines that the second target data have not been received before, the storing module 140 stores the transmission ID code in the second header information received by the first transmitting module 120 or the second transmitting module 130. When the determining module 150 determines that the second target data have been received before, the storing module 140 does nothing but dropping the second packet.

When the determining module 150 determines that the second target data have not been received, the packet processing module 160 performs a corresponding process on the received second target data. When the determining module 150 determines that the second target data have been received before, the packet processing module 160 does nothing but dropping the second packet.

In fact, in the header information of the invention, it also contains a system ID code in addition to the transmission ID code. The system ID code is a system predetermined string for the determining module 150 to determine the legitimacy of the transmitting device that transmits the packet. When the header information 320 in the packet received at the receiving end 100b does not contain the expected system ID code, the determining module 150 determines that the packet is illegal and the receiving end 200b drops it. This prevents the problem of counterfeit packets.

Besides, the transmitting device of the invention further includes a record deleting module 180. When the storing module 140 stores the transmission ID code, it also stores the storing time of the transmission ID data as well. The record deleting module 180 deletes the transmission ID code when the storing time of the transmission ID code exceeds a specific time (e.g., 100 seconds, 2 minutes, etc), when the specific file storing the transmission ID code exceeds a certain size, or when the transmission ID code stored in the specific file exceeds a certain quantity. The transmission ID codes are deleted according to the order by which the transmission ID codes are stored. Hence, the size of the specific file is smaller than a certain size or the number of transmission ID code in the specific file is smaller than a certain quantity.

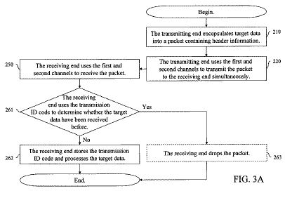

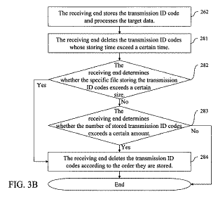

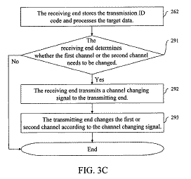

The following embodiment is used to explain how the disclosed system and method operate. Please refer to FIG. 3A for the flowchart of the disclosed method.

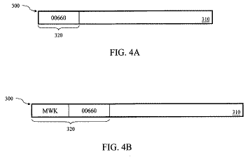

When the transmitting end 100a needs to transmit the target data 310 to the receiving end 100b, the encapsulating module 110 at the transmitting end 100a encapsulates the target data 310 into a packet 300 containing the header information 320 and the target data 310 (step 210). Suppose in this embodiment the header information 320 contains, as shown in FIG. 4A, transmission ID code ‘00660’.

Afterwards, the transmitting end 100a uses the first and second channels to transmit the packet 300 produced by the encapsulating module 110 to the receiving end 100b via the first transmitting module 120 and the second transmitting module 130, respectively (step 220). In this embodiment, the first channel uses a frequency in the band of 2.4 G Hz, and the second channel uses a frequency in the band of 5 G Hz.

The receiving end 100b uses the same first and second channels as the transmitting end 100a (i.e., 2.4 G Hz and 5 G Hz) to wait and receive the packet 300. Thus, under normal conditions, after the transmitting end 100a uses the first and second channels to transmit the packet 300 (step 220), the first transmitting module 120 and the second transmitting module 130 on the receiving end 100b use the first channel and the second channel respectively to receive the same packet 300 transmitted from the transmitting end 100a (step 250).

According to the wireless data transmission properties, the first transmitting module 120/the second transmitting module 130 on the receiving end 100b may receive the packet 300 transmitted from the transmitting end 100a before the second transmitting module 130/the first transmitting module 120. However, whether the first transmitting module 120 or the second transmitting module 130 first receives the packet 300 transmitted from the transmitting end 100a, the determining module 150 of the receiving end 100b uses the header information 320 contained in the received packet 300 to determine whether the received target data 310 have been received by the other transmitting module (step 261).

Suppose in this embodiment, the first transmitting module 120 receives the packet 300 before the second transmitting module 130 (but the invention is not limited to this possibility). The determining module 150 uses the transmission ID code in the header information 320 to determine whether the target data 310 have been received before. After the first transmitting module 120 uses the first channel to receive the packet 300 transmitted from the transmitting end 100a, the determining module 150 reads out the transmission ID code ‘00660’ in the header information 320 of the packet 300. It is compared with the contents of a specific file stored in the storing module 140. Since the second transmitting module 130 has not yet received the packet 300, the receiving end 100b has never received the target data 310. Therefore, the specific file stored in the storing module 140 does not have any record of the transmission ID code ‘00660’. After comparing the transmission ID code and the contents in the specific file, the determining module 150 then determines that the target data 310 received by the first transmitting module 120 have not been received before (step 261). Therefore, the storing module 140 stores the transmission ID code ‘00660’ in the header information 320 to the specific file stored in the storing module 140. The packet processing module 160 then processes the target data 310 in the packet 300 (step 262). For example, the target data 310 are transferred to some other device connected with the receiving end 100b.

When the second transmitting module 130 receives the packet 300 whose transmission ID code in the header information 320 is ‘00660’, the determining module 150 reads out the transmission ID code ‘00660’ therein and compares with the contents in the specific file stored in the storing module 140. Since the first transmission module 120 has already received the packet 300 with the transmission ID code, the specific file stored in the storing module 140 has the record of ‘00660’. Therefore, the determining module 150 determines that the packet 300 with the transmission ID code ‘00660’ has been received (step 261). The receiving end 100b thus drops the packet 300 received by the second transmitting module 130 in the second channel (step 263). That is, the storing module 140 does not store this transmission ID code, and the packet processing module 160 does not process the target data 310.

In fact, when the determining module 150 determines whether the received target data 310 have been received before (step 261), it further determines whether the header information 320 contains a system ID code. Suppose in this embodiment the encapsulating module 110 of the invention embeds a system ID code ‘MWK’ into the header information 320 in addition to the transmission ID code while encapsulating the target data into a packet 300, as shown in FIG. 4B. Then the determining module 150 also determines whether the header information 320 of the packet 300 received by the first transmitting module 120 or the second transmitting module 130 contains the system ID code ‘MWK’. If not, then the receiving end 100b immediately drops the packet 300.

In the above-mentioned embodiment, to avoid the size of the specific file stored in the storing module 140 from getting larger and larger, the storing module 140 also stores a storing time of the corresponding transmission ID code in the specific file. In this case, the recording deleting module 180 of the receiving end 100b determines whether the storing time of any transmission ID code has exceeded a certain time (step 281), as shown in FIG. 3B. This can be done before or after the storing module 140 stores the transmission ID code in the header information 320 into the specific file in the storing module 140 (step 262). Besides, the recording deleting module 180 can delete the transmission ID code according to their order (step 284) after it determines that the specific file storing the transmission ID codes exceeds a certain size (step 282) or the number of transmission ID codes therein exceeds a certain amount (step 283).

In summary, it is obvious that the invention differs from the prior art in that the transmitting end 100a uses both first and second channels to transmit a packet encapsulated with the same target data to the receiving end 100b. The receiving end 100b drops the received packet after confirming that it has been received or processes the packet if it has not been received before. Using this technical means, the invention can solve the problems that the data are susceptible to interference during the transmission process and the transmission time becomes longer because data need to be re-sent. In short, the invention reduces the chances of losing data.

To more effectively prevent data from losing due to interference during the transmission process, the receiving end 100b can further include a channel changing module 190 (FIG. 2). As shown in the flowchart of FIG. 3C, the channel changing module 190 determines whether the channels used by the first transmitting module 120 and the second transmitting module 130 need to be changed according to the packet reception conditions thereof (step 291). This is done after the storing module 140 stores the transmission ID code in the header information 320 in the specific file (step 262). For example, the channel changing module 190 determines that if in a certain time the frequency or number of times the first transmitting module 120 receives the packet is higher than the second transmitting module 130, the channel changing module 190 transmits a channel changing signal of changing the second channel to the transmitting end 100a through the first transmitting module 120 or the second transmitting module 130 (step 292). After the transmitting end 100a receives the channel changing signal, it controls its second transmitting module 130 and the second transmitting module 130 of the second receiving end 100b to use the new second channel for transmitting packets 300 according to the message of changing the second channel recorded in the channel changing signal (step 293). Likewise, if the first channel needs to be changed, the transmitting end 100a uses the new first channel for transmitting packets 300 after it receives the channel changing signal transmitted from the receiving end 100b (step 293).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A transmission method that prevents data loss for data transmissions between a transmitting end and a receiving end in a wireless network, the method comprising the steps of:
encapsulating a target data into a packet containing a header information by the transmitting end;
using a first channel and a second channel to transmit the packet from the transmitting end to the receiving end, respectively; and
using the first channel and the second channel to wait and receive the packet at the receiving end and, when the receiving end receives the packet, executing the steps of:
using a transmission identification (ID) code in the header information to determine whether the target data have not been received by the receiving end before, the receiving end stores the transmission ID code and processing target data; and
dropping the packet if the target data have been received before.

2. The method of claim 1, wherein the step of determining whether the target data have been received by the receiving end is done by checking whether the transmission ID code has been stored in a specific file at the receiving end.

3. The method of claim 1 further comprising the step of storing a storing time associated with the transmission ID code being stored and deleting the transmission ID code when the storing time has exceeds a certain time.

4. The method of claim 1 further comprising the step of deleting at least one of the transmission ID codes according to their order when the specific file storing the transmission ID codes exceeds a certain size or the number of the stored transmission ID codes exceeds a certain amount.

5. The method of claim 1 further comprising the step of transmitting a channel changing signal from the receiving end to the transmitting end for the transmitting end to change the first or second channel according to the channel changing signal when the receiving end uses the conditions of receiving the packets via the first and second channels to determine that the first or second channel needs to be changed.

6. A transmission system that prevents data loss, comprising:
a transmitting end, which encapsulates a target data into a packet containing a header information and uses a first channel and a second channel to transmit the packet, the header information including a transmission ID code; and
a receiving end, which uses the first channel and the second channel to wait and receive the packet and, when the packet is received, uses the transmission ID code to determine whether the target data have been received before or not;
wherein the transmission ID code is stored and the target data are processed when the target data have not been received before or the packet is dropped when the target data have been received before.

7. The transmission system of claim 6, wherein the header information further includes a system ID code so that the receiving end drops the packet when it is determined to be illegal by the system ID code.

8. The transmission system of claim 6, wherein the receiving end determines whether the target data have been received by checking whether the transmission ID code has been stored in a specific file.

9. The transmission system of claim 6, wherein the receiving end further stores a storing time when storing the transmission ID code so that when the receiving end determines that the storing time exceeds a certain time, it deletes the corresponding transmission ID code.

10. The transmission system of claim 6, wherein the receiving end deletes at least one of the transmission ID codes according to their order when the specific file storing the transmission ID codes exceeds a certain size or the number of the stored transmission ID codes exceeds a certain amount.

11. The transmission system of claim 6, wherein the receiving end transmits a channel changing signal to the transmitting end for the transmitting end to change the first or second channel according to the channel changing signal when the receiving end uses the conditions of receiving the packets via the first and second channels to determine that the first or second channel needs to be changed.

12. A transmitting device that prevents data loss, comprising:
an encapsulating module, which encapsulates a first target data into a first packet containing a first header information;
a first transmitting module, which uses a first channel to transmit the first packet and to wait and receive a second packet simultaneously, the second packet containing a second target data and a second header information;
a second transmitting module, which uses a second channel to transmit the first packet and to wait and receive the second packet simultaneously;
a determining module, which uses a transmission ID code in the second header information to determine whether the second target data have been received before or not when the first transmitting module or the second transmitting module receives the second packet;
a storing module, which stores the transmission ID code when the determining module determines that the second target data have not been received before; and
a packet processing module, which processes the second target data when the determining module determines that the second target data have not been received before.

13. The transmitting device of claim 12, wherein the transmitting device drops the second packet when the determining module determines that the second target data have been received before.

14. The transmitting device of claim 12, wherein the first header information and the second header information further include a system ID code and the transmitting device drops the packet when the determining module uses the system ID code to determine that the packet is illegal.

15. The transmitting device of claim 12, wherein the determining module determines whether the target data have been received before by checking the transmission ID code has been stored in a specific file of the storing module.

16. The transmitting device of claim 12, wherein the transmitting device further includes a record deleting module, the storing module stores a storing time along with the associated transmission ID code, the record deleting module deletes a transmission ID code therein when the associated storing time exceeds a certain time or deletes at least one of the transmission ID codes according to their order when a specific file storing the transmission ID codes exceeds a certain size or the number of the transmission ID codes exceeds a certain amount.

17. The transmitting device of claim 12, wherein the transmitting device further includes a channel changing module that records the conditions how the first transmitting module and the second transmitting module receive the packets via the first and second channels, uses them to determine whether the first channel or the second channel needs to be changed, and transmits a channel changing signal via the first or second transmitting module when the first channel or the second channel needs to be changed.

18. The transmitting device of claim 12, wherein the first transmitting module or the second transmitting module changes the first channel or the second channel after receiving a channel changing signal.
